(19) United States
(12) Patent Application Publication
(10) Pub. No.: US 2002/0160107 A1
(43) Pub. Date: Oct. 31, 2002

(54) Asphalt paving method including liquid sealer

(76) Inventor: Thomas R. Amon, Elkhorn, WI (US)

Correspondence Address: David B. Smith, Michael Best & Friedrich LLP, 100 East Wisconsin Avenue, Milwaukee, WI, 53202-4108, US

(21) Appl. No.: 10/092,217

(22) Filed: Mar. 5, 2002

Related U.S. Application Data
(60) Provisional application No. 60/287,603, filed on Apr. 30, 2001.

(51) Int. Cl. B05D 5/10; B05D 1/02

(52) U.S. Cl. 427/136; 427/421

(57) ABSTRACT

An asphalt paving method. The paving method includes the acts of laying an uncompacted asphalt mat on a sub-base, the mat having an upper surface, applying a liquid sealer on the asphalt mat, and compacting the asphalt mat.

### RELATED APPLICATIONS

This application claims the benefit of prior filed co-pending provisional patent application, Ser. No. 60/287,603, filed on Apr. 30, 2001.

### FIELD OF THE INVENTION

The invention relates to an asphalt paving method and, more particularly, to a method of sealing the surface of asphalt pavement.

### SUMMARY OF THE INVENTION

In asphalt paving industries, the demand for faster paving methods and increased efficiency is continually increasing. This is particularly true given the high cost of labor and the need for paving companies to compete with one another on price when bidding for jobs. However, the need to quickly pave an area with asphalt is tempered by the need to provide a well constructed paved surface which is able to withstand the traffic and/or storage of heavy vehicles, to endure dramatic temperature changes, and precipitation, and, in some come cases, to provide drainage. Additionally, moisture may work its way into air voids in the pavement, causing additional deformation of the pavement. In climates in which temperatures frequently drop below freezing, the damage by intruding moisture is even more severe because water expands when it freezes.

Air voids are inherently a part of the finished pavement, accommodating expansion of the pavement. However, when connected, the air voids may act as a conduit for moisture through the pavement. Therefore, it is particularly desirable to seal the asphalt to minimize the permeability of the asphalt, thereby keeping water from seeping into air voids in the asphalt. The method of the present invention provides a method of laying an asphalt surface and, immediately thereafter, sealing the surface against the intrusion of moisture. The sealing act is a part of the paving process.

The present invention provides an improved paving method which, among other things, balances the aforementioned needs of speed and durability. More particularly, the present invention provides an asphalt paving method including the acts of laying an uncompacted asphalt mat on a sub-base, applying a liquid sealer on the asphalt mat, preferably, when the asphalt mat is first constructed, and compacting the asphalt mat.

Also, the present invention provides a method including the acts of laying an asphalt mat on a sub-base, partially compacting the asphalt mat, applying a liquid sealer on the asphalt mat, and compacting the asphalt mat. In this embodiment, the asphalt can be partially compacted before the sealer is applied.

In addition, the present invention discloses an asphalt paving method for paving an unpaved road, the method including the acts of laying an uncompacted asphalt mat on an unpaved sub-base, applying a liquid sealer to the asphalt mat, and compacting the asphalt mat to create a traffic surface. In this embodiment, the asphalt is preferably not compacted before the liquid sealer is applied.

The liquid sealer may be any conventional liquid sealer commonly used in asphalt paving industries including, but not limited to, a coal tar emulsion, an asphalt emulsion, plastic materials, genite, or any organic material which may be used in paving and sealing operations. Additionally, the liquid sealer can be applied to the asphalt surface in any number of ways including spraying, painting, coating, spreading, or any other method of applying sealer to asphalt commonly known in the asphalt paving art.

The method of the present invention reduces the intrusion of moisture into the air voids in the pavement after the pavement is constructed for added long-term performance over years of exposure. The reduced permeability is obtained while maintaining other desirable characteristics of the pavement, such as, for example, skid resistance.

Other independent features and independent advantages of the invention will become apparent to those skilled in the art upon review of the following description and drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention. Also, it is understood that the phraseology and terminology used herein is for the purpose of description and should not be regarded as limiting.

In the drawings, wherein like reference numerals indicate like parts:

FIG. 1 is a cross-sectional view of a finished asphalt pavement made using the method embodying the present invention and illustrating the composition of the finished asphalt pavement mat;

FIG. 2 is a cross-sectional view similar to FIG. 1 enlarged to show an uncompacted asphalt mat;

FIG. 3 is a cross-sectional view similar to FIG. 1 with a layer of sealer applied to the asphalt mat;

FIG. 4 is a cross-sectional view similar to FIG. 1 showing the rolling of the asphalt and sealer; and

FIG. 5 is a cross-sectional view of uncompacted asphalt mat being partially compacted by a roller before the application of a sealer.

### DETAILED DESCRIPTION OF THE ILLUSTRATED EMBODIMENT

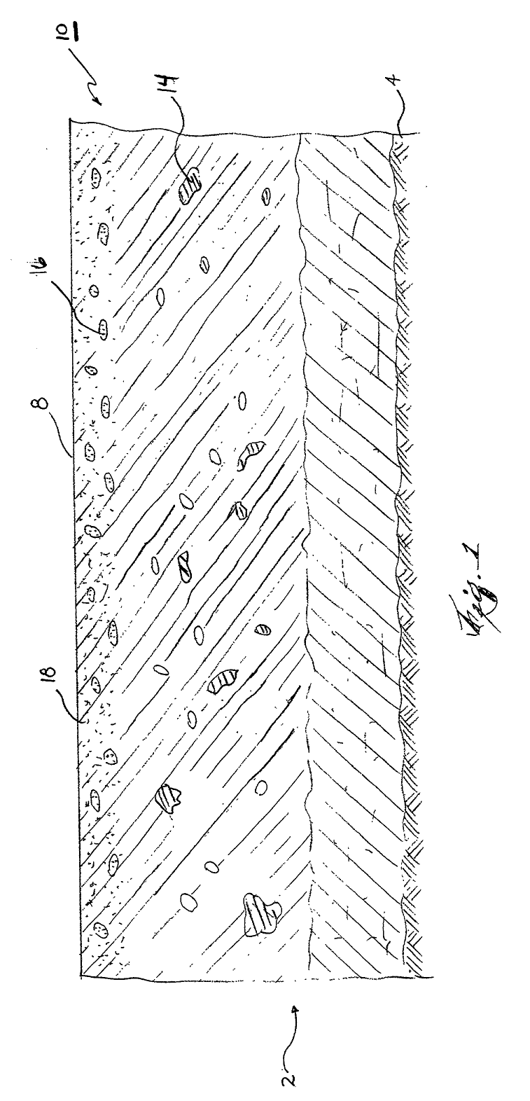

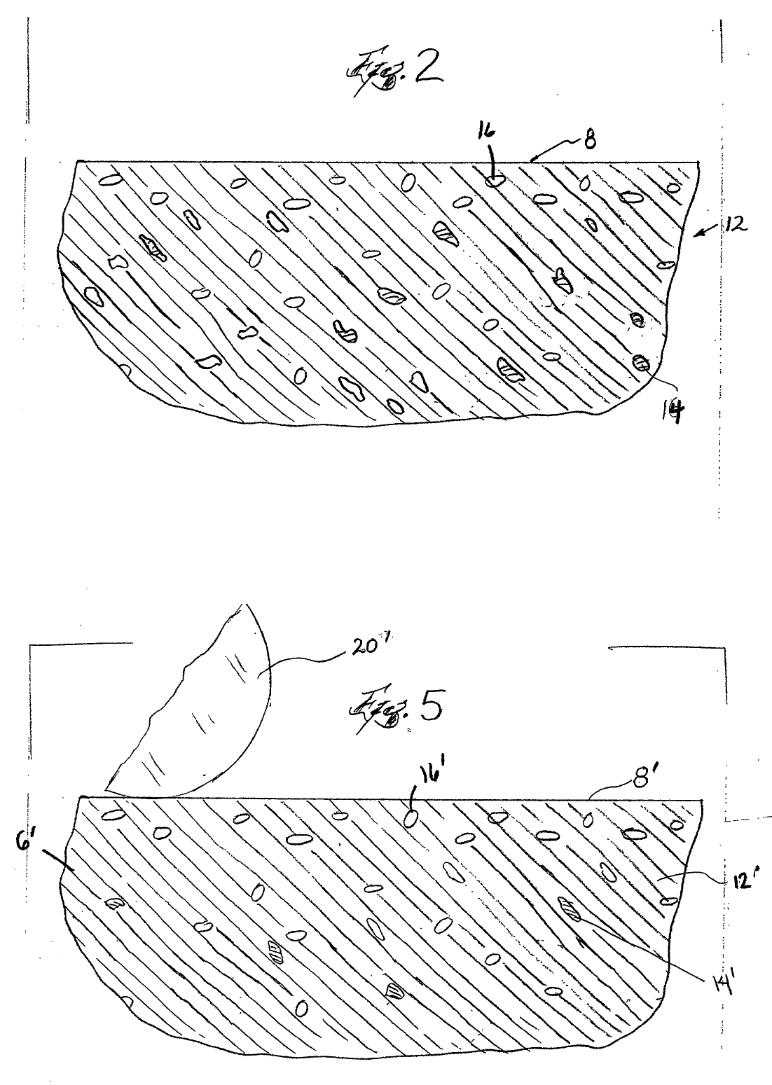

FIG. 1 illustrates an asphalt pavement 10 made using the method embodying the present invention. In the illustrated construction, the asphalt pavement 10 is placed on a sub-base 4 and includes an asphalt mat 2, an asphalt upper surface 8, aggregate 14, air voids 16, and a sealer 18. In different embodiments of the present invention, the asphalt mat 2 may be formed of (see FIGS. 2-4) an uncompacted asphalt mat 12 or (see FIG. 5) a partially compacted asphalt mat 6′.

The sub-base 4 can be any number of different materials but is typically soil, gravel, crushed stone, clay, petroleum materials, or the like. Before laying the uncompacted asphalt mat 12, the paver or, in some cases, another contractor will clear the area intended to be paved, forming the sub-base 4. The sub-base 4 will then be graded, smoothed and prepared for receiving the uncompacted asphalt mat 12. In other constructions (not shown), the asphalt mat 2 may be formed on a layer of existing pavement.

The asphalt mat 2 forms a continuous unbroken longitudinally extending mat of compactible asphaltic paving concrete. The asphalt mat 2 can have any thickness, the thickness being dictated by the intended use of the asphalt pavement 10.

The uncompacted asphalt mat 12 may be laid over the sub-base 4 by any conventional paving method. The particular method of laying the uncompacted asphalt mat 12 may include the use of conventional asphalt pavers or simply involve manually shoveling the asphalt concrete from a container, such as a truck or a wheelbarrow, onto the surface of the sub-base 4. Typically, the uncompacted asphalt mat 12 is applied to the sub-base 4 while the asphalt is relatively warm. The particular methods of spreading and smoothing the compactible asphaltic paving concrete on the sub-base 4 are well known in the art and, accordingly, will not be described in detail herein.

Also, for the purposes of discussion, the term “uncompacted” describes an asphalt mat which has not undergone compaction by a roller or similar device or method, as explained below. For example, when an asphalt mat is laid by a conventional asphalt paver, the paver performs some compaction on the asphalt mat. However, to complete the paving process, additional compaction must be performed on the asphalt mat, for example, by a roller.

The asphalt mat 2 includes (see FIGS. 1-4) particles of aggregate 14. Commonly, the aggregate 14 is a mixture of sand, gravel, and stone. Although not shown to scale in the drawings, the largest pieces of the aggregate 14 typically have a diameter equal to or less than one inch. Most preferably, the aggregate 14 includes a variety of different sizes of particles, engaging and interlocking one another. Conventional asphalt paving aggregate 14 is derived from crushed granite, limestone, gravel, or the like. These sources of aggregate 14 are preferred because they provide sharp, compound edges which, when mixed in the liquid asphaltic cement, tend to create an aggregate interlock that provides strength to the paved surface. However, other materials may be used as aggregate 14 depending upon cost, availability, strength, and other design criteria as dictated by the particular application. The larger and smaller sized fractions of the aggregate 14 are, under normal conditions, uniformly distributed in interlocking relation in the asphalt mat 2 formed by the paving process. However, when the uncompacted asphalt mat 12 is laid, air voids 16 are created and remain in the finished asphalt mat 2.

FIG. 2, while not drawn to scale, shows an embodiment of the present invention in which the asphalt mat 2 is formed from the uncompacted asphalt mat 12. In this embodiment, the uncompacted asphalt mat 12 includes a number of air voids 16. The air voids 16 are defined and surrounded by the uncompacted asphalt mat 12. The air voids 16 are formed as voids between the pieces of aggregate 14. To improve the performance of the asphalt pavement 10, it is desirable to optimize both the size and number of the air voids 16 because the air voids 16, while a necessary part of the finished asphalt pavement 10, can serve as a conduit through the asphalt mat 2. Additionally, water, if left unchecked, is likely to seep into the air voids 16. As discussed above, it is particularly desirable to prevent water from intruding into the connected air voids 16 because water, particularly when in the process of freezing, causes deterioration of the asphalt mat 2 through the stripping or loss of fines from the asphalt mat 2 as the bonding between the asphalt cement and the fine aggregate, sand, and gravel deteriorates. If the surface 8 is left open, moisture can intrude into these air voids 16, freeze, expand, and cause damage to the asphalt mat 2.

It is significant to point out that the term “moisture” as used herein is intended to include rain, snow, sewage, and other forms of water or water mixtures. In addition, moisture is intended to include any other fluid likely to contact the surface of asphalt, including paints, antifreeze, windshield washer fluid, gasoline, break fluid, and other fluids likely to drip out of or off vehicles onto the asphalt pavement 10.

After the uncompacted asphalt mat 12 has been applied to the sub-base 4, it is desirable to coat the uncompacted asphalt mat 12 with a sealer 18. As shown in FIG. 3, a layer of sealer 18 (not shown to scale) is preferably applied to the upper surface 8 of the uncompacted asphalt mat 12. In most cases, because the uncompacted asphalt mat 12 is still relatively hot, any water in the mixture forming the sealer 18 is given off as steam, and the remaining components of the sealer 18 are absorbed into the uncompacted asphalt mat 12. The sealer 18 preferably penetrates the uncompacted asphalt mat 12 and seeps into air voids 16 and the areas in-between the aggregate 14 near the upper surface 8. The sealer 18 therefore provides additional protection for the asphalt mat 2 against the intrusion of moisture.

In different preferred embodiments of the present invention, the sealer 18 can be any conventional sealer 18 used in the asphalt paving industry. Particular sealers commonly used can include a coal tar emulsion, an asphalt emulsion, plastic materials, organic sealers, genite, or other similar sealers known or used in the asphalt paving and sealing industries, including organic materials which may be used in paving and sealing operations.

The sealer 18 can be applied to the uncompacted asphalt mat 12 in any number of ways including, for example, spraying, painting, coating, spreading, or any other method of applying sealer to asphalt commonly known in the asphalt paving or sealing industries. Additionally, the sealer 18 can be applied to the uncompacted asphalt mat 12 at any time after the uncompacted asphalt mat 12 is laid on the sub-base 4 before final compaction of the uncompacted asphalt mat 12. Moreover, the sealer 18 can be applied to the uncompacted asphalt mat 12 immediately or nearly immediately after the uncompacted asphalt mat 12 has been laid on the sub-base 4. The particular method of spreading the sealer 18 may include the use of conventional spraying or spreading equipment or may include manually spreading the sealer with squeegees, trowels, paint brushes, and buckets. While in the preferred embodiment the sealer 18 is sprayed onto the uncompacted asphalt mat 12, the particular method and equipment used to spread the sealer 18 is not important to the present invention and therefore will not be discussed further hereafter.

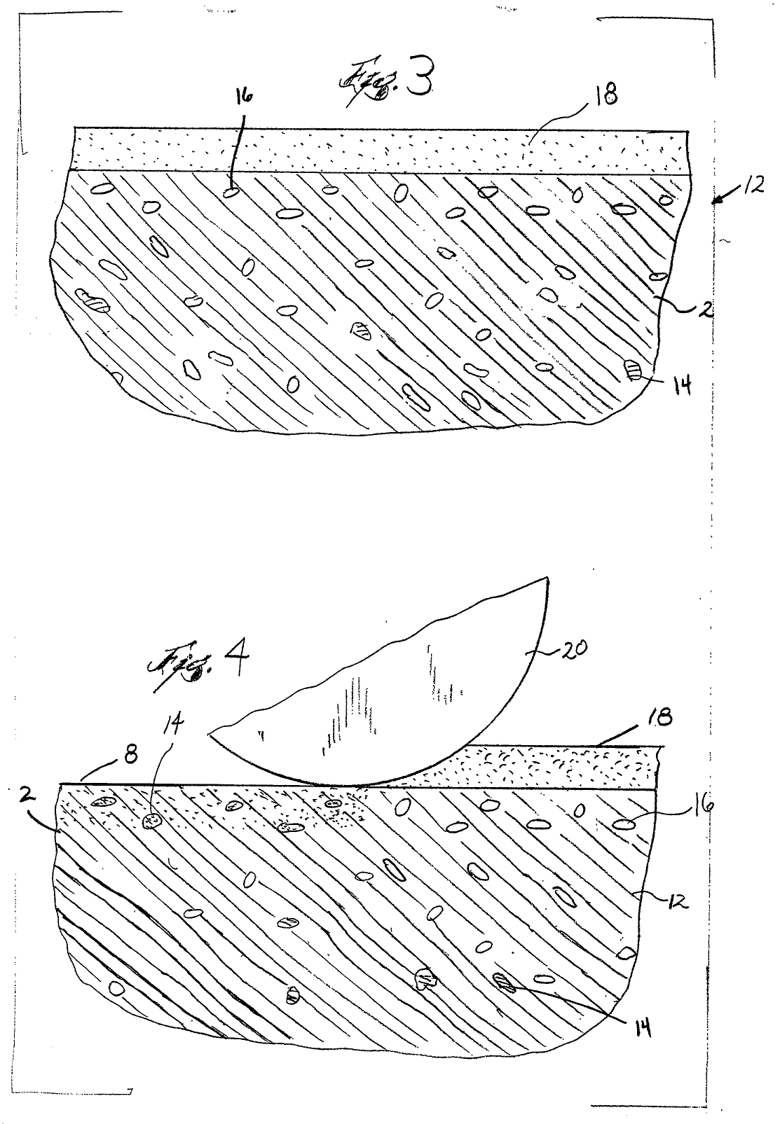

As shown in FIG. 4, the uncompacted asphalt mat 12, including the sealer 18, is then rolled or compacted by a roller 20 so that the smaller pieces of aggregate 14 work their way in-between the larger pieces of aggregate 14. While FIG. 4 depicts a roller 20, the final compacting of the uncompacted asphalt mat 12 can alternatively be accomplished by compacting equipment other than conventional rollers 20. For example, compacting may be accomplished by pounding or stamping the uncompacted asphalt mat 12.

The sealer 18 may be absorbed into the uncompacted asphalt mat 12 when applied and, with final compaction, is pressed into or embedded in the asphalt mat 2 to fill a substantial number or large percentage of the air voids 16 in the uncompacted asphalt mat 12. It is particularly desirable, when compacting the uncompacted asphalt mat 12, to fill or substantially fill air voids 16 at or near the upper surface 8 of the asphalt mat 2. In this manner, sealer 18 fills the air voids 16 and forms a seal on the upper surface 8 of the asphalt pavement 10 to provide improved asphalt pavement and reduce deterioration of the asphalt pavement 10 caused in part by the intrusion of moisture.

Another embodiment of the present invention is partially illustrated in FIG. 5. Except as described below, this embodiment is similar to the first embodiment, and common elements are identified by the same reference number “′”.

In this embodiment, the uncompacted asphalt mat 12′ is laid on the sub-base 4′ as before. However, in this embodiment, before the sealer 18′ is applied, the uncompacted asphalt mat 12′ is partially compacted with a roller to provide a partially compacted asphalt mat 6′.

As shown in FIG. 5, the partially compacted asphalt mat 6′ will include aggregate 14′ of various sizes and shapes and air voids 16′. The air voids 16′ are preferably relatively smaller and relatively less numerous than in embodiments (see FIG. 2) in which the asphalt mat 2 is formed from an uncompacted asphalt mat 12. However, the partially compacted asphalt 6′ does preferably have a relatively significant number of air voids 16′ of a relatively significant size.

In this embodiment, after the uncompacted asphalt mat 12′ is partially compacted, a sealer 18′ is preferably applied to the partially compacted asphalt mat 6′. As described above, the sealer 18′ may be any conventional asphalt sealer including, but not limited to, a coal tar emulsion, an asphalt emulsion, plastic materials, genite, or any organic material which may be used in paving and sealing operations. As described above with reference to the previous embodiment, other similar sealers 18′ known in the art of asphalt paving and sealing can be used for different applications, being selected for the various material properties of the sealers including cost, availability, and water resistance.

Additionally, the sealer 18′ can preferably be applied to the partially compacted asphalt 6′ in any conventional manner including, but not limited to, spraying, painting coating, spreading or any other method of applying sealer to asphalt commonly known in the asphalt paving or sealing industries. The particular method of spreading the sealer 18′ may include the use of conventional spraying or spreading equipment or may include manually spreading the sealer with squeegees, trowels, paint brushes, and buckets.

The partially compacted asphalt mat 6′ is fully compacted after the sealer 18′ is applied. The asphalt compacting can be accomplished by any conventional compacting method including rolling, stamping, tamping, or the like. Additionally, the compacting can be performed manually with hand tools or by any machine or piece (s) of equipment, including powered or towed rollers. Again, the particular manner and equipment used to fully compact the partially compacted asphalt mat 6′ is not important to the present invention.

The embodiments described above and illustrated in the drawings are presented by way of example only and are not intended as a limitation upon the concepts and principles of the present invention. As such, it will be appreciated by one having ordinary skill in the art that various changes in the elements and their configuration and arrangement, and order of application or performance are possible without departing from the spirit and scope of the present invention as set forth in the this description or the attached drawings.

For example, while the present invention is described as including one sealer 18, one having ordinary skill in the art will appreciate that a second layer of the same or a different sealer 18 can be used with or instead of these above described sealers with equal effectiveness. Finally, it will be appreciated by one skilled in the art that the order of the acts in the present method can be changed to a significant extent without departing form the spirit and scope of the present invention.

What is claimed is:

1. An asphalt paving method, the paving method comprising the acts of:
(a) laying an uncompacted asphalt mat on a sub-base, the mat having an upper surface;
(b) applying a liquid sealer on the asphalt mat; and
(c) compacting the asphalt mat.

2. The asphalt paving method as set forth in claim 1, wherein act (b) includes spraying the liquid sealer on the asphalt mat.

3. The asphalt paving method as set forth in claim 1, wherein act (b) includes coating the asphalt mat with the liquid sealer.

4. The asphalt paving method as set forth in claim 1, wherein act (b) includes spreading the liquid sealer on the asphalt mat.

5. The asphalt paving method as set forth in claim 1, wherein the liquid sealer is a coal tar emulsion.

6. The asphalt paving method as set forth in claim 1, wherein the liquid sealer is an asphalt emulsion.

7. The asphalt paving method as set forth in claim 1, wherein the liquid sealer includes a plastic material.

8. The asphalt paving method as set forth in claim 1, wherein the liquid sealer is a genite.

9. The asphalt paving method as set forth in claim 1, wherein act (c) includes rolling.

10. The asphalt paving method as set forth in claim 1, further comprising, before act (b), the act of partially compacting the uncompacted asphalt on the sub-base.

11. The asphalt paving method as set forth in claim 1, wherein a plurality of voids are defined in the asphalt mat adjacent the upper surface, and wherein act (b) includes filling a portion of the plurality of voids with the liquid sealer.

12. The asphalt paving method as set forth in claim 1, further comprising spreading an aggregate on the upper surface.

13. An asphalt paving method, the method comprising the acts of:
(a) laying an asphalt mat on a sub-base, the mat having an upper surface;
(b) partially compacting the asphalt mat;
(c) applying a liquid sealer on the asphalt mat; and
(d) compacting the asphalt mat.

14. The asphalt paving method as set forth in claim 13, wherein act (b) includes rolling.

15. The asphalt paving method as set forth in claim 13, wherein act (c) includes spraying the liquid sealer on the asphalt mat.

16. The asphalt paving method as set forth in claim 13, wherein act (c) includes coating the liquid sealer on the asphalt mat.

17. The asphalt paving method as set forth in claim 13, wherein act (c) includes spreading the liquid sealer on the asphalt mat.

18. The asphalt paving method as set forth in claim 13, wherein act (d) includes rolling.

19. The asphalt paving method as set forth in claim 13, wherein the liquid sealer is a coal tar emulsion.

20. The asphalt paving method as set forth in claim 13, wherein the liquid sealer is an asphalt emulsion.

21. The asphalt paving method as set forth in claim 13, wherein the liquid sealer includes a plastic material.

22. The asphalt paving method as set forth in claim 13, wherein the liquid sealer is a genite.

23. The asphalt paving method as set forth in claim 13, wherein a plurality of voids are defined in the asphalt mat adjacent the upper surface, and wherein act (c) includes partially filling a portion of the plurality of voids with liquid sealer.

24. The asphalt paving method as set forth in claim 13, further comprising spreading an aggregate on the mat.

25. An asphalt paving method for paving an unpaved road, the method comprising the acts of:
(a) laying an uncompacted asphalt mat on an unpaved sub-base, the mat having an upper surface;
(b) applying a liquid sealer on the asphalt mat; and
(c) compacting the asphalt mat to provide a traffic surface.

26. The asphalt paving method as set forth in claim 25, wherein act (b) includes spraying the liquid sealer on the asphalt mat.

27. The asphalt paving method as set forth in claim 25, wherein act (b) includes coating the asphalt mat with the liquid sealer

28. The asphalt paving method as set forth in claim 25, wherein act (b) includes spreading the liquid sealer on the asphalt mat.

29. The asphalt paving method as set forth in claim 25, wherein the liquid sealer is a coal tar emulsion.

30. The asphalt paving method as set forth in claim 25, wherein the liquid sealer is an asphalt emulsion.

31. The asphalt paving method as set forth in claim 25, wherein the liquid sealer includes a plastic material.

32. The asphalt paving method as set forth in claim 25, wherein the liquid sealer is a genite.

33. The asphalt paving method as set forth in claim 25, wherein act (c) includes rolling.

34. The asphalt paving method as set forth in claim 25, further comprising partially compacting the uncompacted asphalt on the sub-base before the act (b).

35. The asphalt paving method as set forth in claim 25, wherein a plurality of voids are defined in the asphalt mat adjacent the upper surface, and wherein act (b) includes filling a portion of the plurality of voids with liquid sealer.

36. The asphalt paving method as set forth in claim 25, further comprising spreading an aggregate on the upper surface.
